(19) United States
(12) Patent Application Publication
(10) Pub. No.: US 2006/0036487 A1
(43) Pub. Date: Feb. 16, 2006

(54) Process for telemarketing

(76) Inventor: John Nicholas Mann, Honolulu, HI (US)

Correspondence Address: JOHN NICHOLAS MANN, 775 KINALAU PLACE # 2207, HONOLULU, HI, 96813, US

(21) Appl. No.: 11/063,791

(22) Filed: Feb. 22, 2005

Related U.S. Application Data
(60) Provisional application No. 60/546,548, filed on Feb. 20, 2004.

(51) Int. Cl. G06Q 30/00

(52) U.S. Cl. 705/14

(57) ABSTRACT

A process is described which provides consumers incentive to actively participate in telemarketing presentations for a set amount of time. This process will also: open up a larger market for the telemarketing industry (including many consumers registering their phone numbers on the national Do-Not-Call list and consumers trading in their land line phones for wireless phones), increase the productivity of call centers, raise the call center's calls to sales-ratio, lower the call center's high rate of employee attrition, eliminate the-possibility for call centers to-make abandoned calls, create a positive and exciting public image for the telemarketing industry, and slow the rate for future government regulation of the telemarketing industry.

This application claims the benefit of the filing date of my provisional patented application:
Patent No. 60,546,548
Filed on Feb. 20, 2004
Title: PROCESS FOR TELEMARKETING

### DESCRIPTION

1. Technical Field

This invention relates to a process for providing ample incentive to consumers to actively participate (answering any questions or offering feedback regarding the presentation whenever asked to do so by the calling agent) in telemarketing calls for a set amount of time (which will be predetermined and announced to the consumer prior to their agreeing to participate in the call). Furthermore, this process will greatly increase the productivity of call centers and also lower the call centers currently high rate of employee attrition. Other benefits of this process include increasing the available market currently open to the telemarketing industry (including consumers who currently have their phone numbers registered on the National Do-Not-Call list and consumers opting to trade in their land line phones for wireless phones), eliminating the possibility fix call centers to make abandoned calls, slowing the rate of future government regulation of the industry, providing positive exposure to companies who participate in this new process, and creating a positive public image for the telemarketing industry.

This new process is comprised of, but not limited to the following: 1) Large daily/weekly/monthly cash prizes. 2) A large ongoing marketing campaign. 3) An outbound telemarketing call utilizing a prerecorded message combined with an automated menu. 4) A website where consumers may register to be called and/or access a toll free number so that they may initiate inbound telemarketing presentations with the call center. Each of these four parts of the overall process is significant and necessary, but no one part may stand on its own. The combination and synergy of the above four features creates a powerful and unique new process of telemarketing.

Telemarketing is the number one medium of direct marketing followed by direct mail and television. The telemarketing industry generates close to $700 billion in annual revenues, employs over 4 million people in the United States and is larger than the entire U.S. restaurant industry. This industry has always been held back by its negative public image. People do not like receiving telemarketing calls in their homes and often vent this frustration on the telemarketing agents who are calling them. This causes a great deal of stress for the telemarketing agent. This public animosity against telemarketing hurts the industry in several ways: 1) It is difficult making a sale to someone who is frustrated by the fact that you are interrupting their private time. Therefore, the average amount of calls converted to sales averages only 3%-4%. 2) The majority of calls the calling agent handles are consumers who either hang up, give a reply such as “no thank you” or “not interested,” or go as far as taking their anger out on the agent. For this reason, the productivity level of call centers is low. In other words, out of all the calls an agent handles, there are few where the agent experiences a pleasant consumer who listens to the pitch, answers questions, gives feedback etc. 3) Due to low productivity and the high level of stress incurred by the calling agent on a continual basis, the attrition rate of call center agents is extremely high—In fact, training and keeping call center agents is the call centers number one expense of doing business. 4) Due to the public animosity regarding telemarketing calls, state and federal governments are reacting with an onslaught of regulations, such as the National Do-Not-Call list which severely restrict the industries means of conducting business.

2. Background Art

The industry has tried to solve the problem of low productivity by focusing on customer relations management (CRM), trying to create better call lists, providing higher standards of training for it's agents, buying more efficient equipment, etc. Some of these initiatives help, but so far, nothing has raised productivity to anywhere near its potential.

Currently, companies try to increase productivity by providing gifts or prizes in order for consumers to attend live presentations, or they give discounts or coupons to consumers willing to make a purchase. This offers little incentive to consumers and does nothing to stop the consumer from quickly hanging up the phone when they realize it is a telemarketing call. U.S. Pat. No. 6,216,111 offers money to be added onto a consumer's credit card in exchange for the consumer answering automated questions after listening to a prerecorded pitch. The small amount of money the consumer will receive provides little incentive to listen to a lengthy presentation. Furthermore, this reward will not generate excitement on behalf of the consumer in order to put them in a “spending/listening frame of mind”. Finally, since the consumer is only listening to recorded messages, this system eliminates the “one to one” element of telemarketing calls which is one of its greatest strengths as a direct marketing medium.

The problem concerning the call center's high rate of employee attrition has been addressed through such things as: employee incentive programs to include commissions and bonuses; better and longer training; more efficient equipment; higher pay; more comfortable and ergonomic work stations, and even workout/weight training rooms set up in call centers. While the above answers do help, the rate of turn over among agents is still extremely high and remains the call centers number one expense of doing business.

This new invention/process offers large daily, weekly and monthly cash prizes to be awarded to randomly selected consumers who have actively participated in a telemarketing call for a set amount of time. Combined with a massive ongoing marketing campaign, this process will generate consumer excitement about participating in telemarketing calls. When a consumer receives a telemarketing call as described by this process, they will first hear the instantly recognizable company name (e.g.—TeleJackpot), which, by then, will be a household name (due to the large ongoing marketing campaign). Hearing this, the consumer will become instantly excited by the chance of winning a large cash prize(s). Then, the prerecorded message will go on to inform the consumer of the prizes to be awarded by the end of that day/week/month, how the call works, and any information required by law to be disclosed. At this point, an automated menu gives them the option to press #1 on their phone pad to be directed to a live agent in order to actively participate in the presentation for a set amount of time and be entered in the drawing; press #2 for an alternate means of entering the drawing (to avoid violating lottery laws, the option of mailing a self addressed 3×5 card must be given in order to eliminate the presents of non-monetary consideration); press #3 for receiving company contact information during regular business hours, and press #4 to have your number added to the companies in house Do-Not-Call list, etc. This menu will ensure that every call routed to the call center agent will be a call where the consumer has already expressed that they will actively participate in the telemarketing call for a set amount of time. This will weed out all “no thank you”/“not interested” reply's, hang-up's, angry people, etc. and will greatly increase the productivity of the call center. The consumer's excitement about the possibility of winning large sums of money will put them in a “spending/listening frame of mind” as opposed to the negative mindset which plagues today's call center agents. This excited and pleasant mindset will cause the consumer to be more open to the act of making a purchase and therefore the percentage of calls converted to sales will increase. Due to the fact that the consumer is in a positive mindset and that both parties are aware that the call will last for a set amount of time, they may relax and engage in pleasant conversation about the product/service. This will drastically reduce the stress of the agents' job while raising his or her productivity. This combination of low stress and high productivity will create an enjoyable and satisfying working environment for the agent which will cause employee turnover to drop along with the expense associated with it. Call centers will make money with far higher productivity while saving money with a greatly reduced rate of employee attrition. Another way this process will lower the call centers high rate of employee attrition is to create an atmosphere which is not only productive and stress free, but also rewarding and exciting for the call center agent. It will do this by awarding a cash prize to every call center agent who makes a winning call to a consumer. For example, when a consumer wins one of the daily/weekly/monthly prizes, then the call center agent who made that call will also receive a cash prize. An example of this would be maybe $1,000 for daily prizes, $5,000 for the weekly prize and $10,000 for the monthly prize. This will further reduce the high rate of employee turn over by providing a more exciting and rewarding atmosphere for the call center agent, due to the fact that they know they have a chance of winning cash prizes themselves.

Recently, due to the public outcry against the telemarketing industry, there has been an onslaught of new government regulations imposed on the industry such as the National Do-Not-Call (DNC) list and laws governing abandoned calls. Call centers utilize predictive dialing systems which call many phone numbers simultaneously. When a consumer answers a call, the predictive dialer will quickly connect that call to a live agent. All too often, the predictive dialing system will contact more consumers than there are available agents. In this case, the system disconnects the call leaving a frustrated consumer on the other end of the line. These are called abandoned calls. The new law regarding abandoned calls states that a call must be connected to a live agent within two seconds of a consumer's completed greeting. Call centers may face fines of up to $11,000 per violation for making abandoned calls. This law will greatly reduce the already low productivity of call centers. Under the new process of telemarketing as described by this invention, when a consumer answers a call, the predictive dialing system will automatically connect the consumer to the prerecorded message and automated menu as described above. Since the predictive dialing system will play the recorded message the instant a consumer answers a call, this will eliminate the call centers liability of accidentally abandoning calls. When a consumer presses #1 on their phone pad to be connected to a live agent as described above, they will hear a message stating, “Due to the excitement generated by (e.g.—TeleJackpot), it may be just a moment before a live agent is available. Please hold for the next available agent.” During this hold time (a few seconds) consumers will be listening to recordings of previous winners screaming with excitement about winning a large cash prize. This will further fuel the consumers' excitement and, at the same time, give the call center the time to produce an available agent to take the call.

Consumers were able to start adding their telephone numbers to the National Do-Not-Call list starting on Jun. 27, 2003. To date, the list has over 100 million phone numbers registered on it. Considering that there are currently only 166 million residential numbers in the U.S., it is obvious that the industry's market is quickly eroding. The industry is expecting to have to lay off up to 2 million employees and loose $50 billion a year in revenues due to these new regulations. To date, there has been no solution to this problem and therefore call centers are downsizing and/or focusing their business towards industry segments which are, so far, unaffected by the new regulations, such as business to business calls, charitable fund raising, political messages, etc. Many companies that tout their products/services via telemarketing are currently considering reallocating these funds towards other mediums of direct marketing. Since telemarketing is the least expensive means for companies to reach their market, this means the cost of these products/services will rise, reflecting a more expensive means of marketing.

This new process/invention is designed to generate a large amount of excitement on behalf of the consumer in receiving this new type of telemarketing call. It takes into consideration that consumers will probably want to participate in calls described by this process, yet avoid having to receive regular telemarketing calls. Therefore, this process provides a means for consumers to participate in these calls, even after registering their phone numbers on the National DNC list. According to current law set forth by the FTC and the FCC, a person may receive telemarketing calls from a company if they have given that company permission to do so, even if their phone number is registered on the National DNC list. This new process includes a website where consumers may register themselves on a “Call-Me” list “granting permission” to be called by all companies licensed to use this new process. This registration page will ask for consumer information such as name, phone number, age, income, hobbies, interests, home owner or renter, and many other important questions. This will prove to be an extremely valuable tool to participating telemarketers since they will not only have a calling list complete with names and numbers of consumers who have asked to be called, but they will also have a good sense of who these people are and what they want, based on the information they have provided.

This website will also provide a means for consumers to call a toll free number combined with the extension number of a certain company listed on the website (all companies licensed to use this process may list their company names on the website) and initiate, at their own convenience, an inbound telemarketing call with individual participating companies. After actively participating in this inbound telemarketing presentation for a set amount of time, they will be entered into the daily/weekly/monthly drawings along with the outbound calls.

Although this new process is shown to be utilized in association with telemarketing, it may be utilized just as readily in association with other technologies such as IVP (Internet Voice Portals) where an E-marketing agent may converse with a consumer via a computer voice portal while presenting a presentation/demonstration via the consumers computer monitor. The consumer will gain access to these presentations via the same website described as being part of this new process. This process may also be used in conjunction with other technologies such as DRTV (Direct Response T.V.) where people may press a button on their T.V.'s remote control during a commercial to have that company give them a telemarketing call. No matter what the medium, the consumer must be willing to actively participate in the presentation/demonstration for a set amount of time in order to be entered into the drawings.

Today, millions of consumers are abandoning their land line telephones for portable (wireless) phones. Due to growing privacy and legal issues surrounding telemarketing to a portable phone (e.g.—Cell Phone) the telemarketing industry is loosing even more of its market. Laws normally make exception for consumers who “have asked to be called.” It is highly doubtful that a consumer will ask to be called on their portable phone unless there is some incentive for them to do so. This new process provides that incentive and therefore will open up yet another market which is becoming closed off to telemarketers.

There are several benefits of the massive ongoing marketing campaign described in this new process. 1) It will generate an enormous amount of public excitement in receiving this new type of telemarketing call, therefore putting consumers in a spending/listening frame of mind. 2) It will inform the public about the website, where consumers may register themselves on the “Call-Me” list and receive these telemarketing calls while avoiding regular telemarketing calls by registering their names on the National DNC list. 3) It will inform the public that they may go to this website to initiate, at their own convenience, toll free inbound telemarketing calls to particular companies listed on the website. 4) It will motivate non-participating call centers and companies engaging in telemarketing to gain license to this process, therefore making the process self growing. The more companies that gain license to this process, the more revenues will be generated. When more revenue is generated then more money can be spent on cash prizes and marketing. This will equate to more public excitement which leads to higher productivity. It is a win/win for everyone involved. 5) It will provide positive exposure to companies licensed to use this process. For example, when a national radio ad airs, consisting of a consumer yelling “thank you!” and shrieking with excitement about winning the (e.g.—$5 million) monthly prize, the narrator in the ad will reply “Don't thank us, thank (e.g.—Geico Insurance), they cared enough to call you.” 6) It will cause consumers to associate telemarketing with excitement therefore, creating a public acceptance of these calls. With the telemarketing industry's new public acceptance and positive image, the government will no longer be so hard pressed to impose future regulations on the industry.

This process will generate revenues by charging companies a licensing fee on a per call basis. These revenues will support the large ongoing marketing campaign, all cash prizes, and other expenses associated with this process of telemarketing.

Other objects, features and advantages of the present invention/process will become more fully apparent from the following detailed description of the presently preferred embodiments for carrying out the invention/process and the accompanying drawings.

### BRIEF DESCRIPTION OF DRAWING

FIG. 1 is a flow chart describing the presently preferred embodiment of the path of an outbound telemarketing call.

FIG. 2 is a flow chart showing the continuation of the call as described in FIG. 1.

FIG. 3 is a flow chart describing the presently preferred embodiment of the means for a consumer to participate in an inbound presentation/demonstration via the website described in this invention.

FIG. 4 is a flow chart describing the presently preferred embodiment of the presentation process between the consumer and the live agent.

FIG. 5 is a flow chart describing the presently preferred embodiment of the creation of financial support for the ongoing marketing campaign and large cash prizes, described as being part of this invention.

FIG. 6 is a flow chart describing the presently preferred embodiment for this new process to raise call center productivity as compared with the low rate of call center productivity associated with the current process of telemarketing.

FIG. 7 is a flow chart describing the presently preferred embodiment for this new process to raise the call center's calls to sales ratio as compared with the low calls to sales ratio experienced with the current process of telemarketing.

FIG. 8 is a flow chart describing the presently preferred embodiment for this new process to drastically lower the call centers employee rate of attrition as compared with the extremely high rate of employee attrition experienced by call centers under the current process of telemarketing.

FIG. 9 is a flow chart describing the presently preferred embodiment for this new process to create a larger market for itself by circumventing the National Do-Not-Call list, as compared to the quickly eroding market being experienced by the current process of telemarketing due to the National Do-Not-Call list.

FIG. 10 is a flow chart describing the presently preferred embodiment for this process to greatly slow the rate of future government regulation of the telemarketing industry as compared to the rapidly increasing government regulation being imposed on the industry under the current process of telemarketing.

FIG. 11 is a chart describing the presently preferred embodiment of the synergy between the three main elements making up the outbound call portion of this new process. Each element of this process is important and necessary, although it is the combination of these elements which creates the synergy necessary to make this process powerful and unique.

FIG. 12 is a chart describing the presently preferred embodiment of the synergy between the three main elements making up the portion of this new process described as being an inbound call (initiated by the consumer) utilizing a toll free number and participating company extension, which are located on the website. Each element of this process is important and necessary, although it is the combination of these elements which creates the synergy necessary to make this process powerful and unique.

FIG. 13 is a chart describing the presently preferred embodiment of the synergy between the four main elements making up the portion of this new process described as, being an outbound call based on the Website's Call-Me list. Each element of this process is important and necessary, although it is the combination of these elements which creates the synergy necessary to make this process powerful and unique.

### BEST MODES FOR CARRYING OUT INVENTION/PROCESS

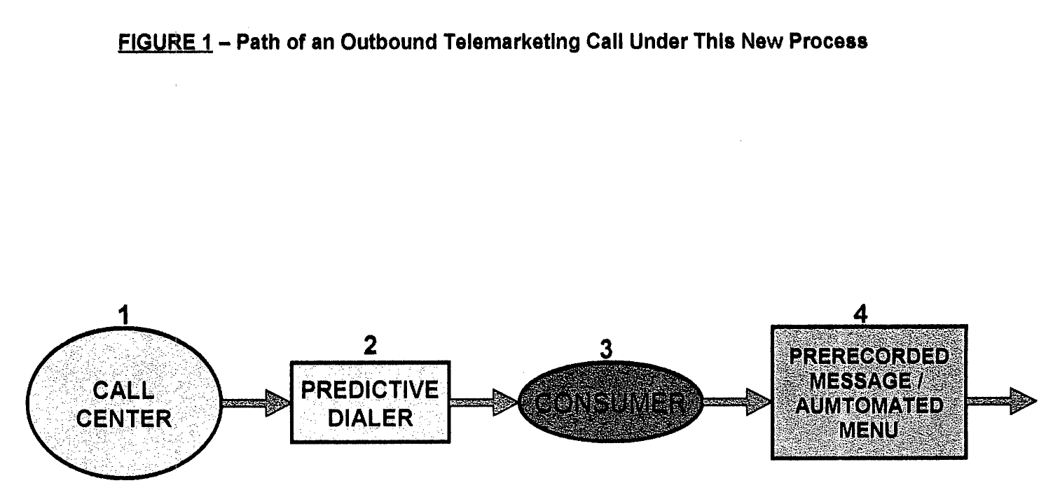

The presently preferred best modes for carrying out the present invention are illustrated by way of example in FIGS. 1 through 10.

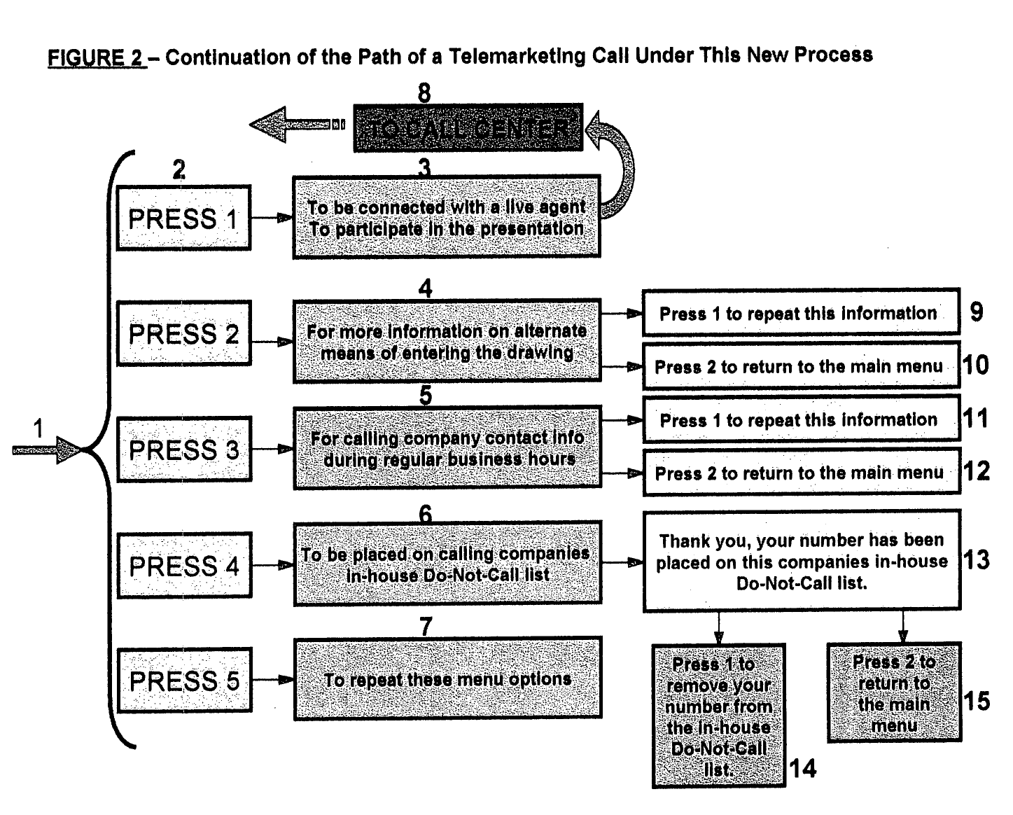

Referring to FIGS. 1 and 2, shown is a first preferred embodiment of the path of an outbound telemarketing call. No. 1 on this chart refers to the call center which generates an outbound call. No. 2 shows that this call center is contacting consumers via a predictive dialer system. This system dials many telephone numbers simultaneously and when a consumer answers their phone, the system quickly transfers that call to a live agent at the call center. All too often, the predictive dialer calls more people than there are available agents. When this happens, the system disconnects the call leaving a frustrated consumer on the other end of the line. Due to the public outcry over this type of call, strict government regulations have recently been put into place stating that a call must be routed to a live agent within 2 seconds of the consumers, completed greeting or the call center may face fines up to $11,000 per violation. This law is justified, although it will greatly reduce the already low productivity of the call center. Under the new process of telemarketing described by this invention, after the predictive dialer connects to a consumer, a prerecorded message (No. 4) instantly plays. This may seem to be a violation of the abandoned call law since a “prerecorded message” is not a “live agent” and therefore the call is not connected to a “live agent” within two seconds. The law also states that a prerecorded message may be delivered to a consumer as long as the consumer has given that company permission to do so. The prerecorded message immediately states the instantly recognizable company name (e.g.—TeleJackpot) which, because of the massive ongoing marketing campaign, will be a household name and will generate excitement due to the fact that the consumer will know that they have a chance to win large cash prizes if they participate in the call. Then, the prerecorded message will go on to inform the consumer of the prizes to be awarded by the end of that day/week/month, how the call works, and any information required by law to be disclosed. At this point, an automated menu gives them the option to press #1 on their phone pad to be directed to a live agent in order to actively participate in the presentation for a set amount of time and be entered in the drawing, press #2 for an alternate means of entering the drawing (to avoid lottery laws, the option of mailing a self addressed 3×5 card must be given in order to eliminate the presents of non-monetary consideration), press #3 for receiving company contact information during regular business hours, press #4 to have your number added to the companies in house Do-Not-Call list, or press # 5 to repeat these menu options. These options are shown by Numbers 3 through 15 on FIG. 2. If the consumer presses #1 on their phone pad, they will bear a message stating that, “due to the excitement generated by (e.g.—TeleJackpot) it may be a moment before an agent is available to take the call. Please hold for the next available agent. During the following hold period (preferably no more than a few seconds) the consumer will be listening to recordings of past winners screaming with excitement about winning millions in cash prizes. This will further excite the consumer while, at the same time, allowing an agent to become available without violating the new abandoned call laws. Also, when the consumer presses # 1 on their phone pad, an electronic hit is automatically sent to the main (e.g.—TeleJackpot) computer terminal for accounting purposes. If a specific company's billing doesn't reflect the amount of hits the main computer has received, this will give cause to investigate the irregularity with that particular company.

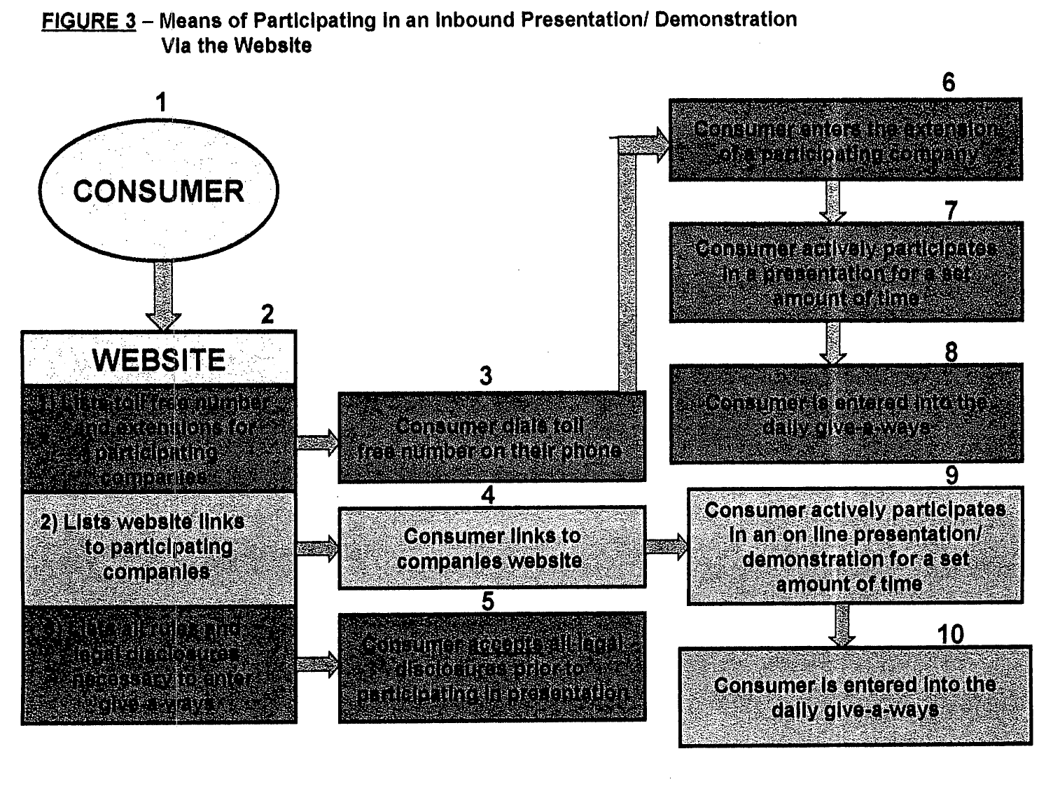

Referring to FIG. 3, shown is the presently preferred embodiment of the means for a consumer to participate in an inbound presentation/demonstration via the website described in this invention. No. 1 on this chart represents the consumer, who may access a website (No. 2) in order to participate in an inbound presentation/demonstration. This will allow the consumer to participate in a presentation/demonstration at the time of their choice and with the company of their choice. This will make telemarketing more convenient to many consumers. The consumer simply finds the toll free number on the website and calls it, along with the extension number of a participating company listed on the website. The call will be answered by a call center agent who will then provide a presentation for the consumer. After the consumer has actively participated in this, presentation for a set amount of time, the agent will enter them in the drawings. Entering a consumer into the drawings takes just the press of a button since the consumer's name and phone number are already present on the agents monitor, all the agent has to do is send the information to the list on the main computer terminal from which winners are randomly selected. Via the website, consumers will also have the option to connect to a participating companies' website for an online presentation/demonstration. As with presentations over the phone, the consumer must actively participate in the online demonstration for a set amount of time before being entered into the drawings.

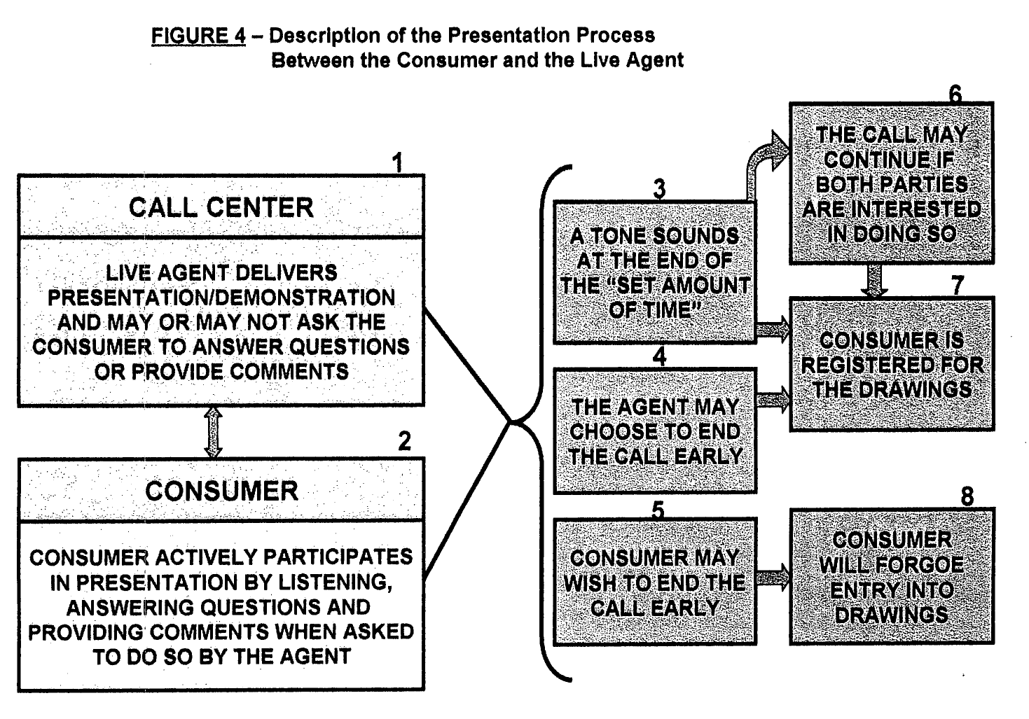

Referring to FIG. 4, shown is the presently preferred embodiment of the presentation process between the consumer and the live agent. Number—1 in this figure shows the agent at the call center initiating a call to a consumer (No. 2). The agent may or may not ask questions or ask for the consumers comments regarding the presentation. The consumer must answer all questions and provide comments regarding the presentation whenever asked to do so by the agent during the set amount of time determining the length of the presentation, which the consumer has already agreed to. Answering questions and providing comments regarding the presentation whenever asked to do so by the agent shows that the consumer is actively participating in the presentation. At the end of the set amount of time which determines the length of the presentation, a tone will sound (No. 3) informing both parties that the requirements for the consumer to be entered into the drawings have been met. At this point, if both parties are interested in doing so, the call may continue and the consumer will be entered in the drawings whenever the consumer or the agent decides to end the call. Either party may choose to end the call at the sound of the tone at which time the consumer will be entered into the drawings. The agent may choose to end the call early (before the tone sounds), but must still register the consumer in the contest if this is done. The agent might do this if he or she determines that the product/service will not meet the needs of the consumer. An example of this may be that the agent is selling home owner insurance and the consumer is a renter. Rather than waste time, the agent may thank the consumer for their time, end the call and register the consumer in the drawings. If however, the unlikely event should arise that the consumer decides to end the call before the sound of the tone, they forgo being entered into the drawings.

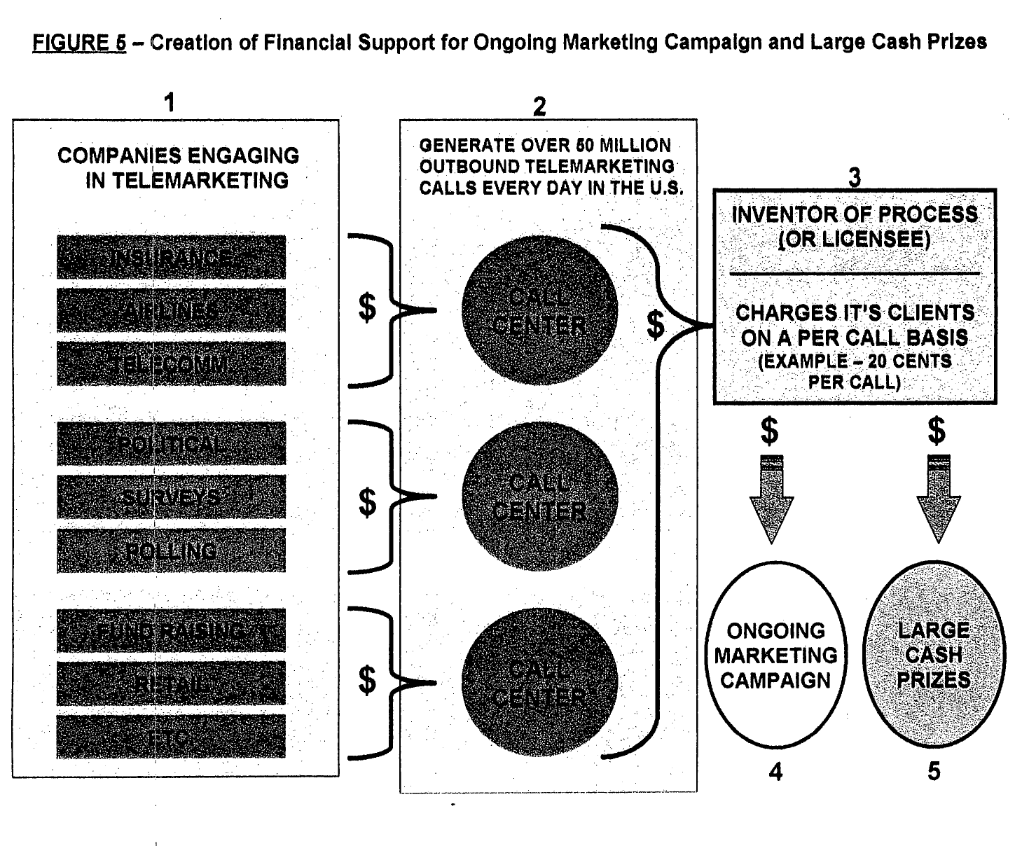

Referring to FIG. 5, shown is the presently preferred embodiment of the creation of financial support for the ongoing marketing campaign and large cash prizes described as being part of this invention. Number 1 in this chart shows some examples of the different types of companies that engage in telemarketing. These companies either have their own call centers or they outsource their telemarketing to professional call centers (No. 2). Either way, they pay money to engage in telemarketing and expect a certain return on their investment. Companies licensed to use this new process of telemarketing will pay on a per call basis. Since there are currently over 50 million outbound business to consumer telemarketing calls made every day in the United States, even at just a 20 cent per call charge and a 10% market share (over 5 million calls a day) this would generate revenues of over $1 million a day, 365 days a year=over $365 million annually. The massive ongoing marketing campaign described by this process will not only excite consumers to want to participate in this process of telemarketing, but it will also excite and motivate other telemarketing companies to want to gain license to this process. This will make the process self growing and will therefore quickly dominate the market. At only 20 cents per call with a 60% market share, this process will generate revenues well over $2 billion annually in the U.S. alone. As revenues increase, so will the cash prizes and the amount of money put into the marketing campaign which will further fuel the excitement. With this extremely large revenue base, it will be easy to give away prizes which will provide ample excitement and incentive for consumers to want to participate in this new telemarketing process. It will also be easy to put a minimum of $100 million annually into the massive ongoing marketing campaign which plays a vital role in this new process/invention.

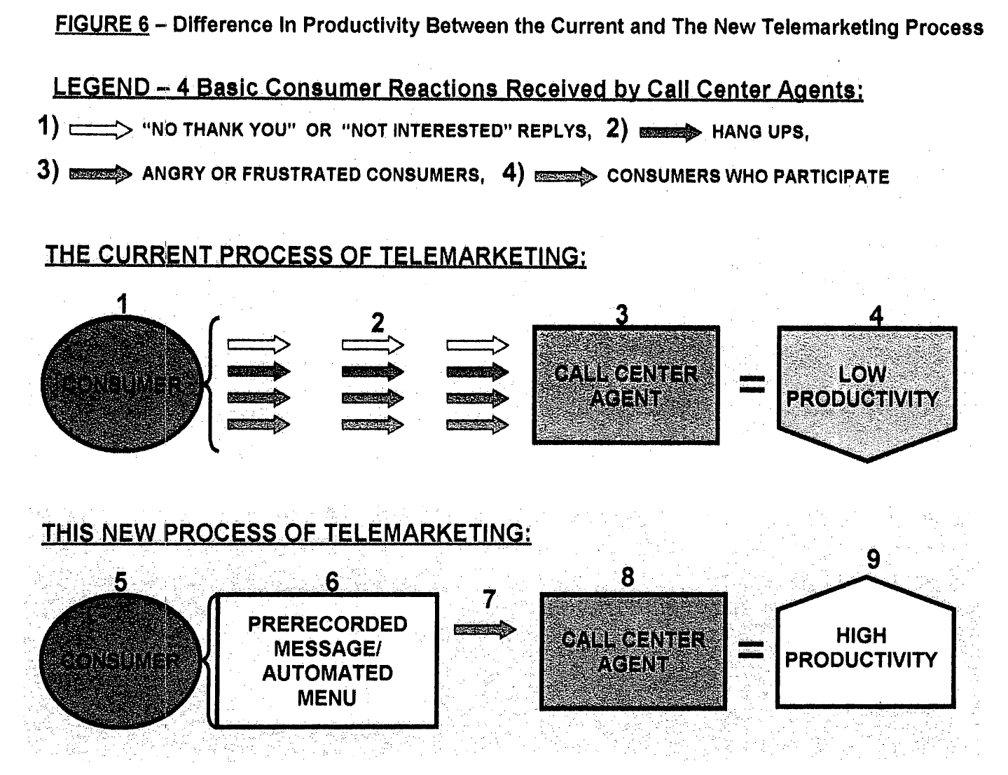

Referring to FIG. 6, shown is die presently preferred embodiment for this new process to raise call center productivity as compared with the low raw of call center productivity associated with the current process of telemarketing. Number 1 and 2 on this chart shows the various reactions given by consumers in response to receiving a telemarketing call under the current process of telemarketing. Number—3 on this chart shows the call center agent who receives these responses from consumers after initiating telemarketing calls. The most common response received by the agent is the consumer hanging up their phone when they realize it is a telemarketing call. The next most common type of response is a “No thank you” or “Not interested reply”. The third most common response from consumers in answering a telemarketing call is to vent, on the agent, their frustration in receiving telemarketing calls during their private time at home. The least likely response is a pleasant consumer who listens to the pitch answers questions, provides comments, etc. Therefore, under the current process of telemarketing, the call center is spending the vast majority of its time and resources just trying to get someone to listen to their pitch. Out of the few consumers who actually listen to the pitch, not many actually go on to make a purchase. Numbers 5 and 6 on the chart shows the consumer receiving a telemarketing call under this new process of telemarketing. The consumer receives a prerecorded message with an automated menu which is described in detail in FIG. 1 above (the presently preferred embodiment of the path of an outbound telemarketing call.). This will weed out all “hang ups,” “No thank you” or “Not interested” replies, angry people, etc. This means that the only type of calls the call center agent will handle will be consumers who have already agreed to actively participate in the presentation for a set amount of time. Better yet, consumers who are excited about the possibility of winning millions of dollars in cash prizes. This will drastically increase the call centers productivity making it far less expensive to conduct its business with far better results.

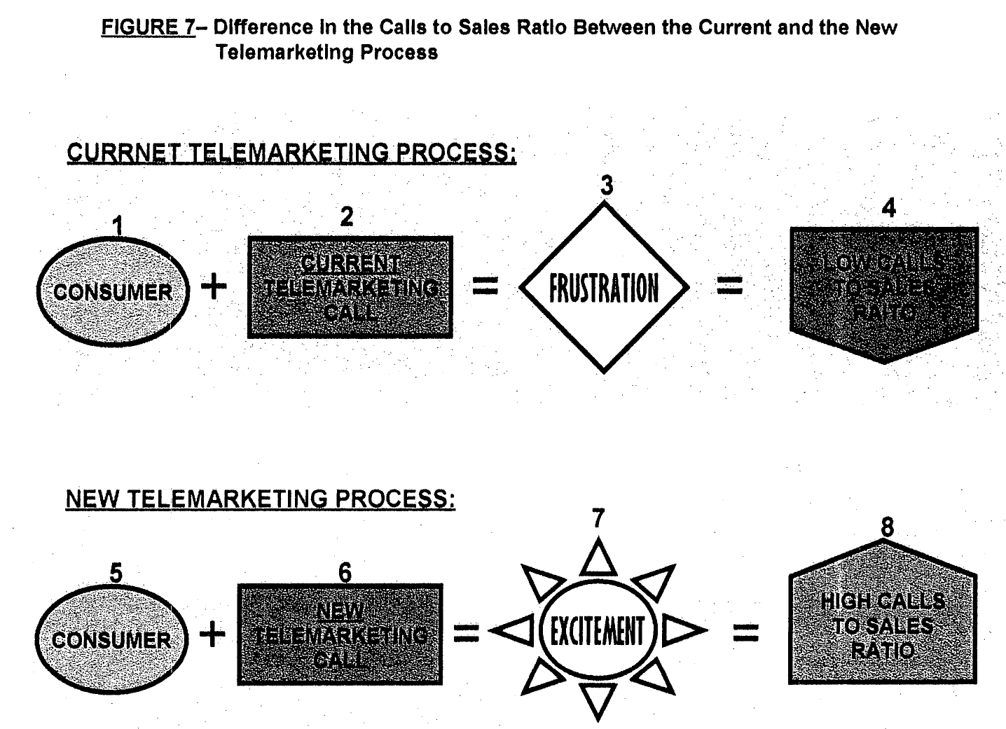

Referring to FIG. 7, shown is the presently preferred embodiment for this new process to raise the call centers calls to sales ratio as compared with the low calls to sales ratio experienced with the current process of telemarketing. With the current process of telemarketing, the amount of calls converted to sales is only 3%-4%. This is because the majority of consumers passionately despise receiving telemarketing calls. It is extremely difficult to make a sale to someone who is frustrated by the fact that you are intruding on their private time at home in order to sell them something they haven't asked for. Numbers 1-4 on this chart shows the current process of telemarketing and how it leads to the currently low calls to sales ratio. Numbers 5-4 on this chart show the new process of telemarketing as described by this invention. This new process will award large daily, weekly and monthly cash prizes to randomly selected consumers who have actively participated in a telemarketing call for a set amount of time. There will preferably be 10 cash prizes to be awarded at the end of each and every day. This will make consumers feel that they have a better chance of winning a prize. These prizes will preferably be $10,000 each. Only daily prize winners (70 of them for the week) will be entered into the weekly drawing to be awarded at the end of each week. The weekly prize will preferably be $1 million. Again, only daily prize winners during the month will be entered into the monthly drawing, which will preferably be $5 million, to be awarded at the end of each month. This system will increase the excitement and motivation to participate in every telemarketing call because even though daily calls only award $10,000, they are the only way to be entered into the larger weekly and monthly give-a-ways. This would provide the chance for one consumer to possibly win $6,010,000.00 in one month. These figures should provide ample incentive for consumers to not only welcome, but look forward to receiving telemarketing calls. What is also important to note is the fact that, the more calls you participate in, the more chances you have in winning. As revenues generated by this new process of telemarketing raise, so will the cash prizes. This will further fuel the excitement and level of participation of consumers and will also inspire nonparticipating companies to gain license to this process, therefore making it self growing. As mentioned earlier, the massive ongoing marketing campaign will bombard various marketing mediums with exciting news of new winners, the large prizes they have won and which companies made the winning calls. All of this excitement will put the consumer in a “spending/listening frame of mind” as apposed to the defensive mindset which plagues today's call center agents. The consumer will be so excited by receiving the telemarketing call that they will happily listen to the agents pitch, answer questions and comments, and will be far more likely to make a purchase since they are in an excited and positive frame of mind. For this reason, the calls to sales ratio of call centers, licensed to use this new process of telemarketing will soar, which will drastically increase their ROL. Another example of this affect would be the case of survey calls or political messages. A very low percentage of people participate in surveys or messages. Why should they—after all, people have busy lives, and it's not like they are being compensated for their time. With this new process of telemarketing they will far more likely participate in a survey or political messages because they know they will have a chance to win millions of dollars if they do.

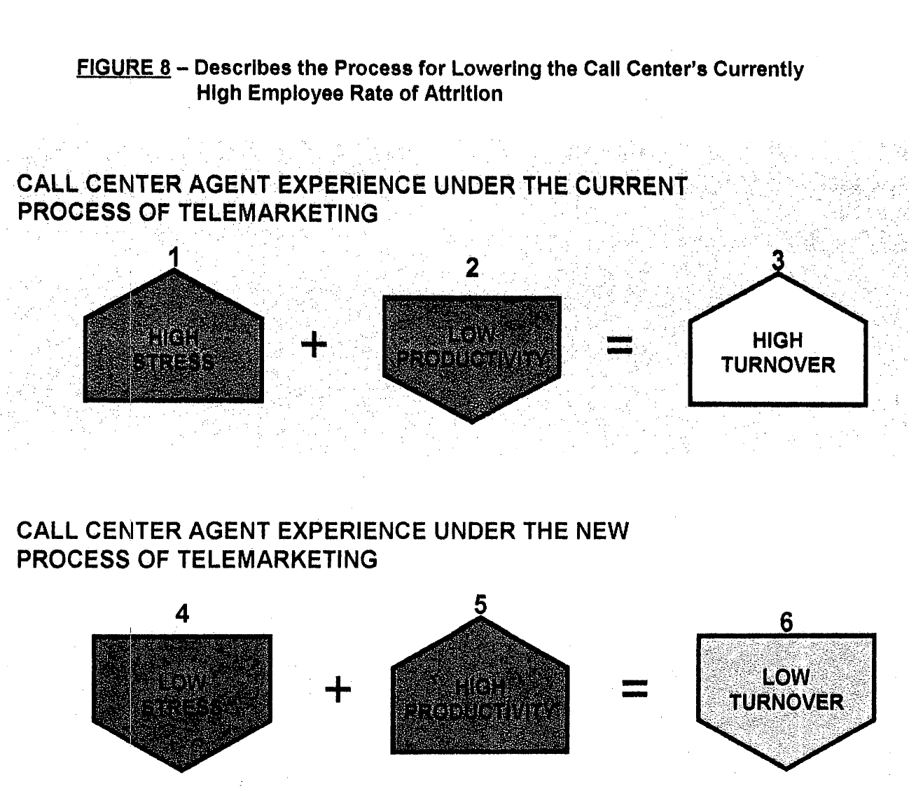

Referring to FIG. 8, shown is the presently preferred embodiment for this new process to drastically lower the call centers employee rate of attrition as compared with the extremely high rate of employee attrition experienced by call centers under the current process of telemarketing. Numbers 1-2 on this chart represent the high level of stress, and low productivity incurred by call center agents on a continual basis. This stress is caused by several factors: 1) dealing with consumers who vent their anger on the agent on a continual basis causes a high level of stress in and of itself. More and more consumers are taking this negative and aggressive attitude towards telemarketers. In fact, this public outcry against the telemarketing industry is why the state and federal governments are cracking down on the industry so aggressively. 2) Call center agents are under a great deal of pressure from their managers to produce. When you are dealing with a market which is becoming more hostile it becomes extremely challenging to make sales (produce). Therefore, this raises the already high level of stress for call center agents. 3) Some call center agents work on a low hourly wage combined with a commission and some get paid strictly commission based on their productivity. Since it is becoming more difficult to make sales with the present market, this also raises the level of continuous stress incurred by the agent. 4) Yet another form of stress incurred by the call center agent on a continual basis is the negative stigma attached to the telemarketing industry. Many call center agents fear telling people what they do for a living because they feel people will get angry with them or look down on them. With the image the telemarketing industry has, being a call center agent is not a job which invokes pride. This raises the level of stress associated with the job even higher. Due to the low productivity and high level of stress associated with the current process of telemarketing, the rate of employee attrition at call centers is extremely high. In fact, training and keeping call center employees is the call centers number one expense of doing business. Call centers spend hundreds of millions of dollars annually due to this problem which will continue to get worse as the industry's public image continues to decline. The new process of telemarketing as described by this invention is represented by Numbers 4-6 on this chart. With this new process, every call handled by a call center agent will be a call consisting of an excited consumer who is in a “spending/listening frame of mind” who has already expressed that they will actively participate in the presentation for a set amount of time. This will drastically raise the agents' productivity. Since both parties are aware that the call will last for a set amount of time, they may both relax and participate in easy conversation about the product/service being pitched. This will greatly reduce the level of stress incurred by the agent. With this high productivity and low stress, the level of employee attrition will drop significantly, as will the expense associated with it

Another reason this new process will reduce the level of turnover at the call center is because this process will provide an exciting and rewarding atmosphere for the call center agent. This will be done by awarding prizes to call center agents who have made the daily, weekly and monthly winning calls to consumers. In other words, if an agent has made one of the daily winning calls, then they will receive a (e.g.—$1,000.00) cash prize. They will receive a (e.g.—$5,000.00) cash prize for making the winning weekly call. Or, they will receive a (e.g.—$10,000) cash prize for making the winning monthly call. With this exciting atmosphere and chance to win large prizes, turnover rates will drop sharply.

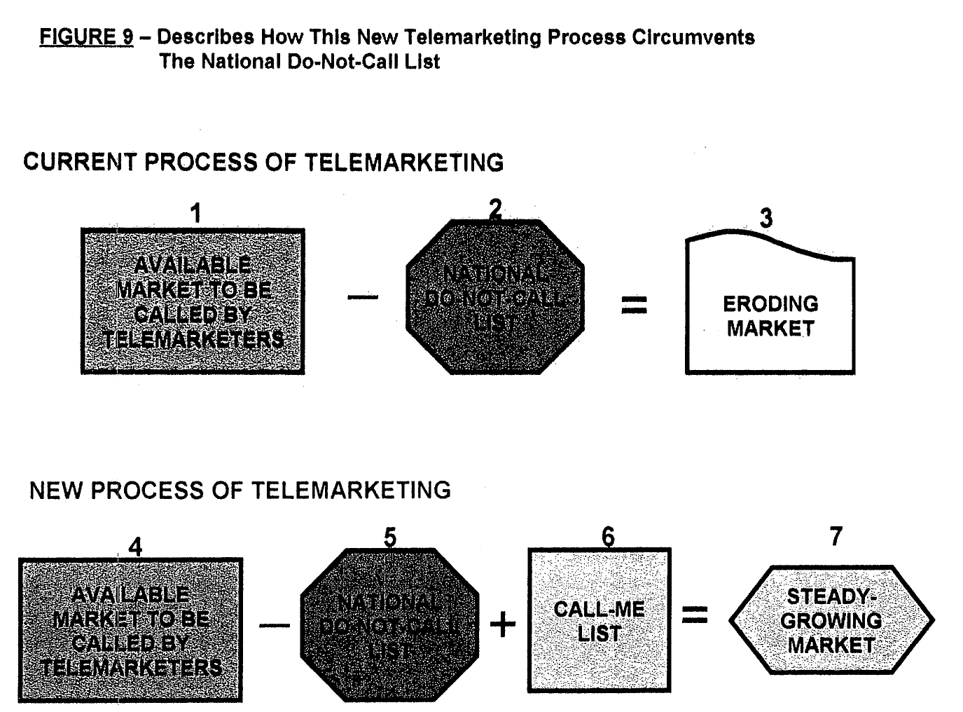

Referring to FIG. 9, shown is the presently preferred embodiment for this new process to create a larger market for itself by circumventing the National Do-Not-Call list, as compared to the quickly eroding market being experienced by the current process of telemarketing due to the National Do-Not-Call list. Numbers 1-3 on this chart represent the current process of telemarketing. The available business to consumer (B to C) market is currently 166 million residential phone numbers in the United States. So far, over 100 million phone numbers are registered on the list. There are 54 million B to C telemarketing calls made every day in the U.S. according to the FCC. As the National DNC list grows, the amount of residential phone numbers available to telemarketers shrinks proportionately. This will cause the consumers who have not put their numbers on the National DNC list to start receiving a higher frequency of daily calls until they are driven to add their numbers to the list. It won't take long before the telemarketing industry calls itself right out of business. Numbers 4-7 on this chart reflect the new process of telemarketing as described by this invention. This new process/invention is designed to generate a large amount of excitement on behalf of the consumer in receiving this new type of telemarketing call. It takes into consideration that consumers will probably want to participate in calls described by this process, yet avoid having to receive regular telemarketing calls. Therefore, this process provides a means for consumers to participate in these calls, even after registering their phone numbers on the National DNC list. According to current law set forth by the FTC and the FCC, a person may receive telemarketing calls from a company if they have given that company permission to do so, even if their phone number is registered on the National DNC list. This new process includes a website where consumers may register themselves on a “Call-Me” list “granting permission” to be called by all companies licensed to use this new process. This registration page will ask for consumer information such as name, phone number, age, income, hobbies, interests, home owner or renter, and many other important questions. This will prove to be an extremely valuable tool to participating telemarketers since they will not only have a quickly growing calling list complete with names and numbers of consumers who have asked to be called but they will also have a good sense of who these people are and what they want based on the information they have provided. This new process will provide consumers, who are interested in receiving telemarketing calls in exchange for the chance to win millions of dollars, the means to do so. All other consumers may simply add their numbers to the National DNC list. This ensures that there will always be a market available to telemarketers, which is being proven not to be the case with the current form of telemarketing.

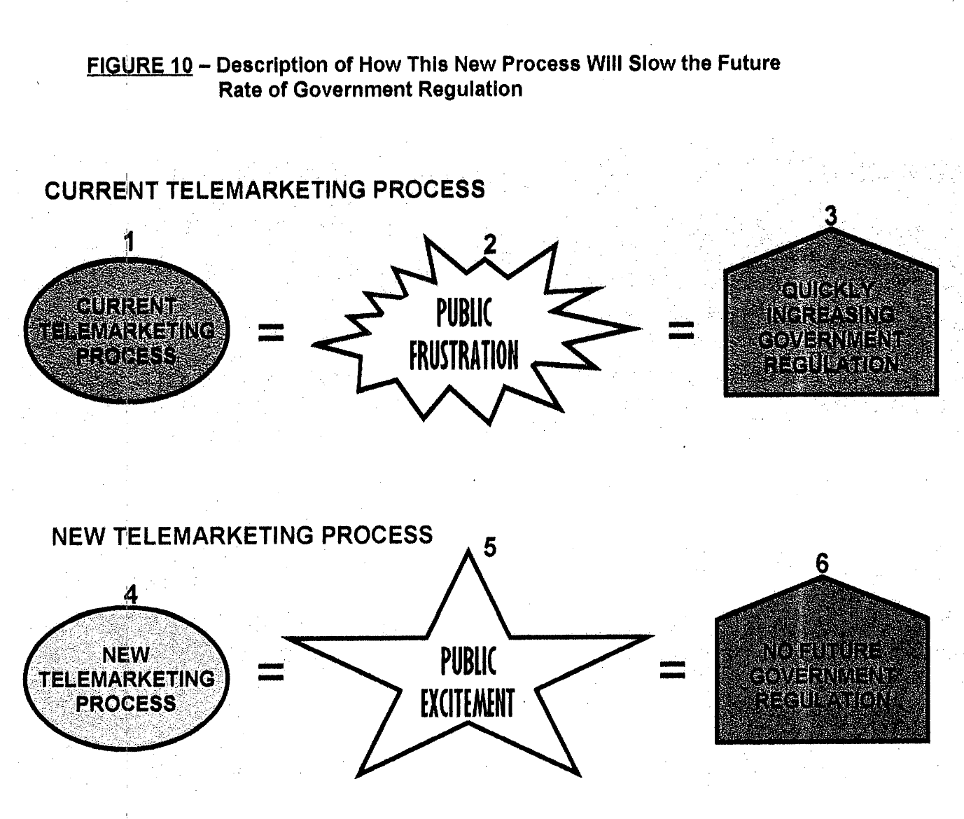

Referring to FIG. 10, shown is the presently preferred embodiment for this new process to greatly slow the rate of future government regulation of the telemarketing industry as compared to the rapidly increasing government regulation being imposed on the industry under the current process of telemarketing. The latest laws created by the federal government to eliminate unwanted telemarketing calls received by consumers are the most popular government action in the history of our government. This gives some perspective to just how upset people are by receiving telemarketing calls in their homes. With the combination of these new government regulations and this new process of telemarketing, there will be no more public outcry against the telemarketing industry, and therefore, the federal government will have no need to impose future regulations on the industry. People who don't want to receive telemarketing calls may add their numbers to the National DNC list and people who would like to participate in telemarketing calls for a chance to win millions of dollars may add their names/numbers to the “Call-Me” list described as being part of this process. Everybody is happy. On the other hand, under the current process of telemarketing, people will continue to get upset at telemarketers, which will cause the federal government to continue to impose future regulations until the industry is driven out of business.

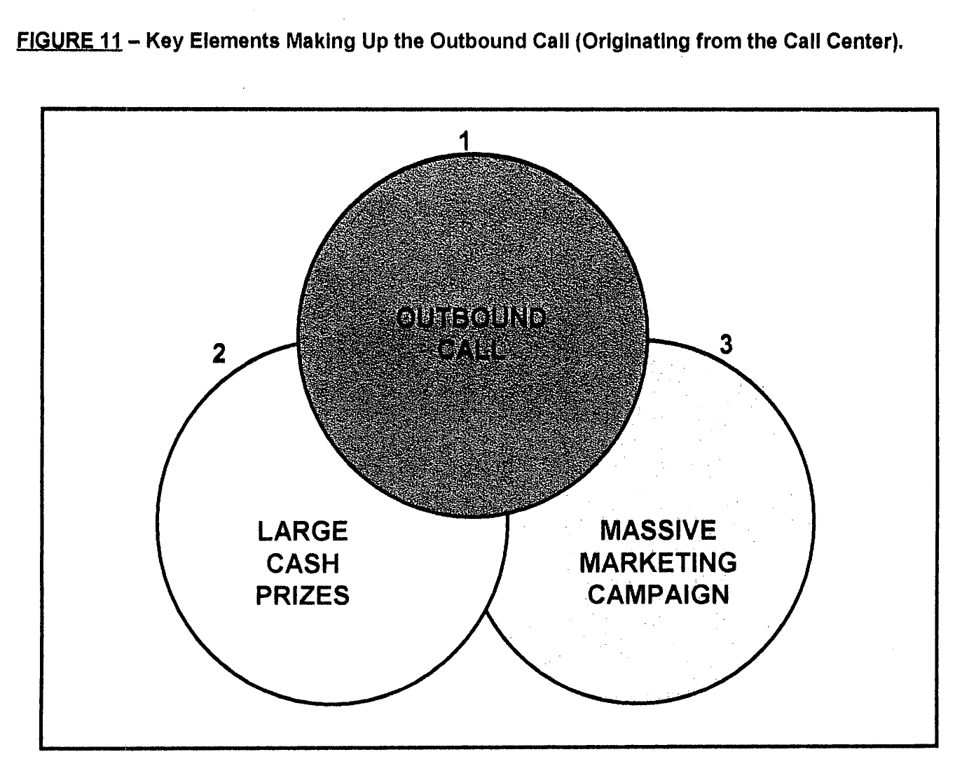

Referring to FIG. 11, shown is the presently preferred embodiment of the three main elements making up the outbound call portion of this new process. Numbers 1-3 in this figure show the interrelationship between the elements making up the outbound call portion of this new process. Each of these elements is important and necessary, although not sufficient on their own. The combination and synergy of these elements makes this process unique and powerful. For instance, the outbound call which consists of the prerecorded message and the automated menu is very important to this new process, but without the massive marketing campaign there would be no public awareness which means no public excitement. This would undermine the whole process. Furthermore, without large cash prizes there would be no incentive for consumers to agree to actively participate in the telemarketing call for a set amount of time. Only when these elements are combined do they create a powerful and unique new process of telemarketing.

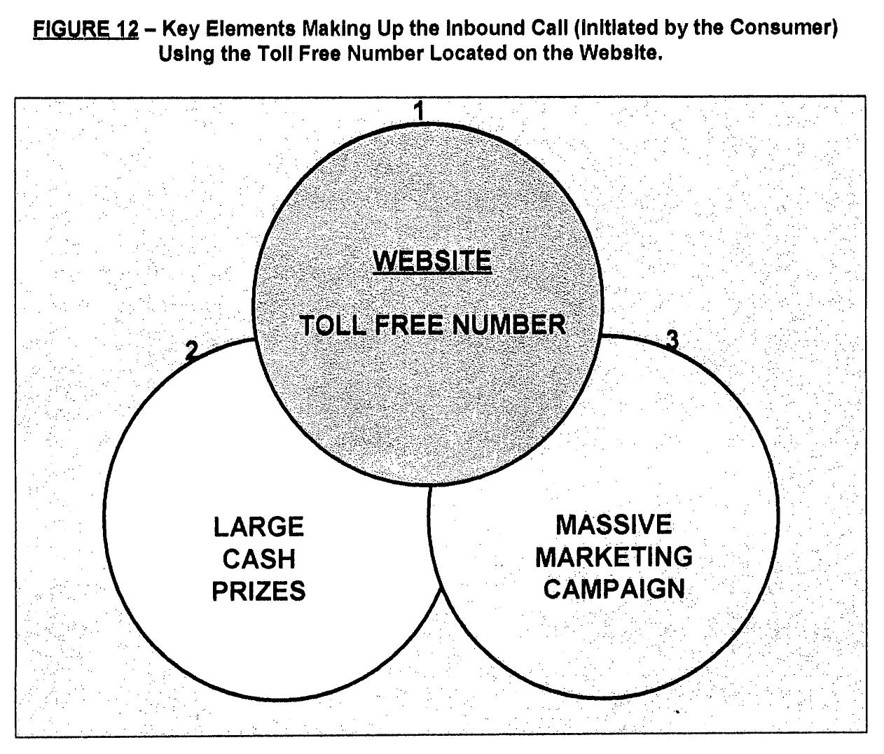

Referring to FIG. 12, shown is the presently preferred embodiment of the three main elements making up the portion of this new process described as being an inbound call (initiated by the consumer) utilizing a toll free number and participating company extension, which are located on the website. Numbers 1-3 in this figure show the interrelationship between the elements making up an inbound call (from the consumer) utilizing the toll free number and a participating companies extension number which are found on the website described as being part of this new process. Each of these elements is important and necessary, although not sufficient on their own. The combination and synergy of these elements makes this new process of telemarketing powerful and unique. For instance, without the massive ongoing marketing campaign, consumers wouldn't be aware of the website or the toll free number described as being part of this process. This would undermine the entire process. Also, without the large cash prizes, even if consumers did stumble onto the website, there would be no incentive for them to call the toll free number and participate in an inbound telemarketing call. Without the website's toll free number consumers wouldn't be able to participate in telemarketing calls at their own convenience. Many consumers aren't home during regular telemarketing hours, therefore, their only means of participating in a telemarketing presentation would be to initiate it themselves during off hours. Only when these elements are combined do they create a powerful and unique new process of telemarketing,

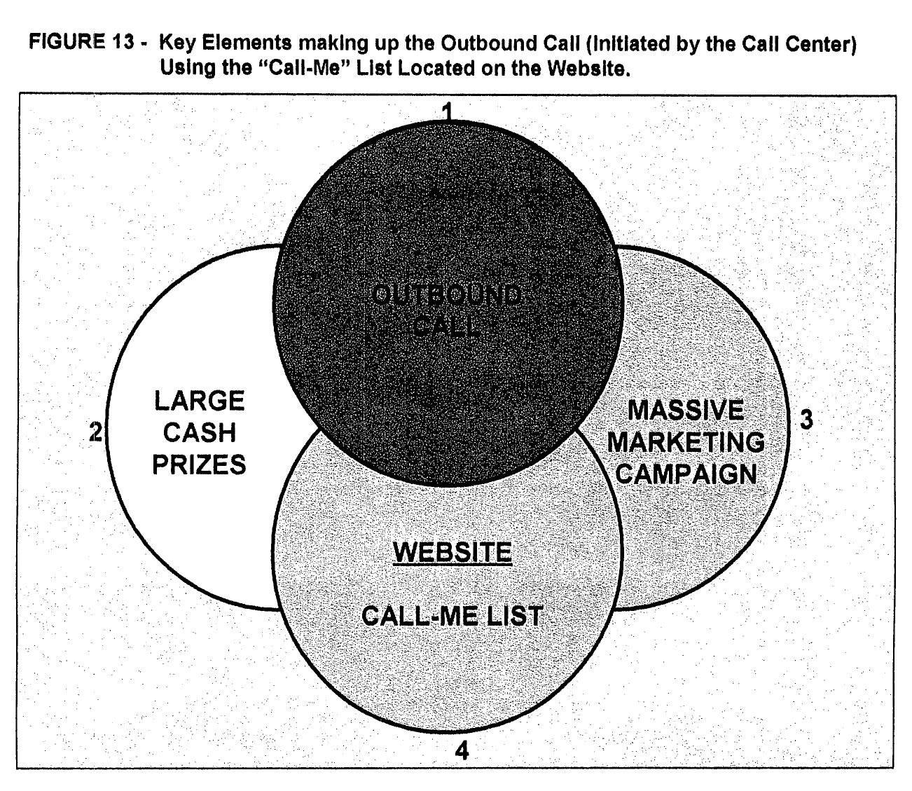

Referring to FIG. 13, shown is the presently preferred embodiment of the four main elements making up the portion of this new process described as being an outbound call based on the Website's Call-Me list. Numbers 1-4 in this figure show the interrelationship between the elements making up an outbound call based on the website's Call-Me list. Each of these elements is important and necessary, although not sufficient on their own. The combination and synergy of these elements makes this new process of telemarketing powerful and unique. For instance, without the website's Call-Me list, this process would not be able to circumvent the National Do-Not-Call list. By allowing consumers who are registered on the National DNC list to “request to be called” by registering on the website's Call-Me list, they may circumvent the National D0-Not-Call list and continue to receive telemarketing calls described by this process while avoiding regular telemarketing call. As with FIGS. 12 and 13, without the massive ongoing marketing campaign and the large cash prizes, there would be no awareness or incentive on behalf of the consumer to participate in telemarketing calls described by this new process.

While the present invention has been disclosed in connection with the presently preferred embodiments described herein, it should be understood that there may be other embodiments which fall within the spirit and scope of the invention as defined by the claims. For example, this invention may be practiced in association with other technologies or direct marketing mediums now known or hereafter invented, including (but not limited to) VoIP (Voice over I.P.) and DRTV (Direct Response T.V.). This process may be conducted over a telephone, computer, any other current or future applicable means of communication, or any combination thereof. Accordingly, no limitations are to be implied or inferred in this invention except as specifically and explicitly set forth in the claims.

Industrical Applicability (Note to Martin Hsia—I'm not Really Sure What Should be Included in this Section)

1. A process of telemarketing comprising:
large daily/weekly/monthly cash prizes;
an outbound telemarketing call utilizing a prerecorded message combined with an automated menu;
a website offering, among other things, a means for consumers to participate in other forms of presentations (e.g.—inbound, internet, etc.) and a means for consumers to register themselves on a “Call Me” list; and
a large ongoing marketing campaign utilizing various mediums, such as radio, TV, print etc.
